(19) United States
(12) Patent Application Publication
(10) Pub. No.: US 2009/0046090 A1
(43) Pub. Date: Feb. 19, 2009

(54) ACTIVE MATRIX DISPLAY DEVICES

(75) Inventor: David Andrew Fish, Haywards Heath (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/091,596

(22) PCT Filed: Oct. 16, 2006
(86) PCT No.: PCT/IB06/53800

§ 371 Date: Apr. 25, 2008

(30) Foreign Application Priority Data
Oct. 26, 2005 (EP) 05110017.0

(51) Int. Cl. G09G 5/00

(52) U.S. Cl. 345/214

(57) ABSTRACT

An active matrix display device comprises an array of display pixels, each pixel comprising a current-driven light emitting display element (2), a drive transistor (22) for driving a current through the display element (2) and a storage capacitor (30) for storing a voltage to be used for addressing the drive transistor (22). A discharge transistor (36) is used for discharging the storage capacitor (30) thereby to switch off the drive transistor in dependence on the light output of the display element (2). The storage capacitor (30) is adapted to store a voltage which is a function of the threshold voltage of the drive transistor (22). In this way, two-level compensation is provided for threshold voltage variations of the drive transistor, one using a current sampling approach and one using optical feedback. This can extend the lifetime of the display.

This invention relates to active matrix display devices, particularly but not exclusively active matrix electroluminescent display devices having thin film switching transistors associated with each pixel.

Matrix display devices employing electroluminescent, light-emitting, display elements are well known. The display elements may comprise organic thin film electroluminescent elements, for example using polymer materials, or else light emitting diodes (LEDs) using traditional III-V semiconductor compounds. Recent developments in organic electroluminescent materials, particularly polymer materials, have demonstrated their ability to be used practically for video display devices. These materials typically comprise one or more layers of a semiconducting conjugated polymer sandwiched between a pair of electrodes, one of which is transparent and the other of which is of a material suitable for injecting holes or electrons into the polymer layer.

The polymer material can be fabricated using a CVD process, or simply by a spin coating technique using a solution of a soluble conjugated polymer. Ink-jet printing may also be used. Organic electroluminescent materials can be arranged to exhibit diode-like I-V properties, so that they are capable of providing both a display function and a switching function, and can therefore be used in passive type displays. Alternatively, these materials may be used for active matrix display devices, with each pixel comprising a display element and a switching device for controlling the current through the display element.

Display devices of this type have current-addressed display elements, so that a conventional, analogue drive scheme involves supplying a controllable current to the display element. It is known to provide a current source transistor as part of the pixel configuration, with the gate voltage supplied to the current source transistor determining the current through the display element. A storage capacitor holds the gate voltage after the addressing phase.

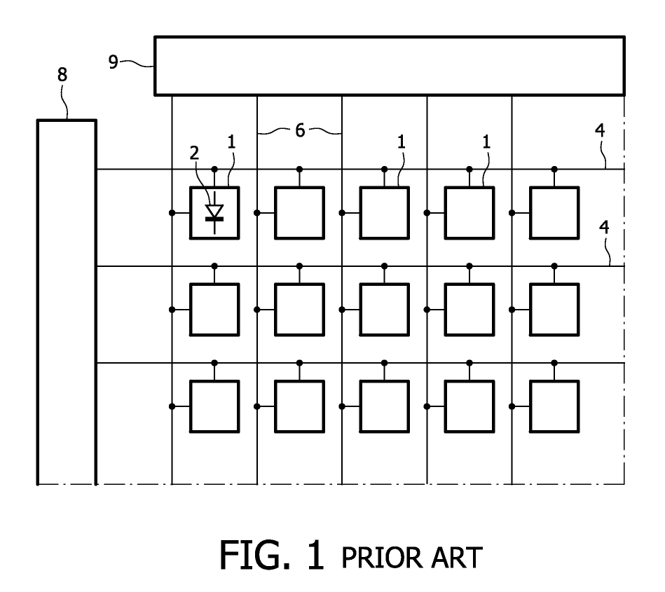

FIG. 1 shows the layout of an active matrix addressed electroluminescent display device. The display device comprises a panel having a row and column matrix array of regularly-spaced pixels, denoted by the blocks 1 and comprising electroluminescent display elements 2 together with associated switching means, located at the intersections between crossing sets of row (selection) and column (data) address conductors 4 and 6. Only a few pixels are shown in the Figure for simplicity. In practice there may be several hundred rows and columns of pixels. The pixels 1 are addressed via the sets of row and column address conductors by a peripheral drive circuit comprising a row, scanning, driver circuit 8 and a column, data, driver circuit 9 connected to the ends of the respective sets of conductors.

The electroluminescent display element 2 comprises an organic light emitting diode, represented here as a diode element (LED) and comprising a pair of electrodes between which one or more active layers of organic electroluminescent material is sandwiched. The display elements of the array are carried together with the associated active matrix circuitry on one side of an insulating support. Either the cathodes or the anodes of the display elements are formed of transparent conductive material. The support is of transparent material such as glass and the electrodes of the display elements 2 closest to the substrate may consist of a transparent conductive material such as ITO so that light generated by the electroluminescent layer is transmitted through these electrodes and the support so as to be visible to a viewer at the other side of the support. Typically, the thickness of the organic electroluminescent material layer is between 100 nm and 200 nm. Typical examples of suitable organic electroluminescent materials which can be used for the elements 2 are known and described in EP-A-0 717446. Conjugated polymer materials as described in WO96/36959 can also be used.

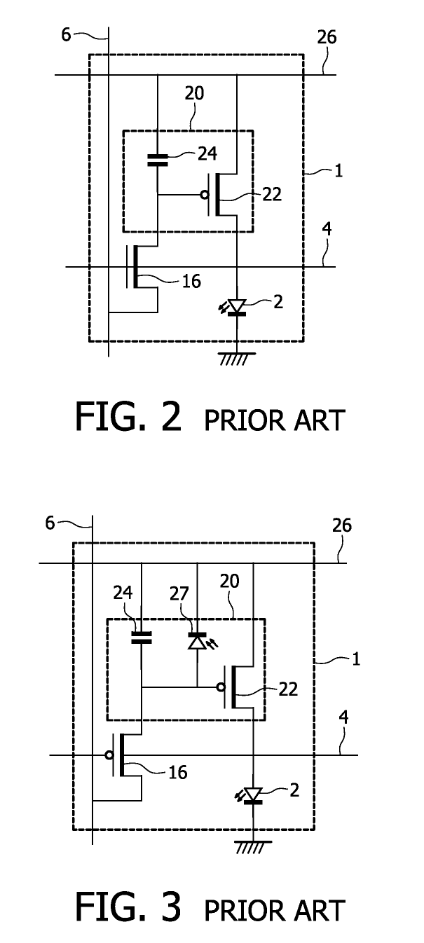

FIG. 2 shows in simplified schematic form the most basic known pixel and drive circuitry arrangement for providing voltage-addressed operation. Each pixel 1 comprises the EL display element 2 and associated driver circuitry. The driver circuitry has an address transistor 16 which is turned on by a row address pulse on the row conductor 4. When the address transistor 16 is turned on, a voltage on the column conductor 6 can pass to the remainder of the pixel. In particular, the address transistor 16 supplies the column conductor voltage to a current source 20, which comprises a drive transistor 22 and a storage capacitor 24. The column voltage is provided to the gate of the drive transistor 22, and the gate is held at this voltage by the storage capacitor 24 even after the row address pulse has ended.

The drive transistor 22 in this circuit is implemented as a p-type TFT, so that the storage capacitor 24 holds the gate-source voltage fixed. This results in a fixed source-drain current through the transistor, which therefore provides the desired current source operation of the pixel.

In the above basic pixel circuit, for circuits based on polysilicon, there are variations in the threshold voltage of the transistors due to the statistical distribution of the polysilicon grains in the channel of the transistors. Polysilicon transistors are, however, fairly stable under current and voltage stress, so that the threshold voltages remain substantially constant.

The variation in threshold voltage is small in amorphous silicon transistors, at least over short ranges over the substrate, but the threshold voltage is very sensitive to voltage stress. Application of the high voltages above threshold needed for the drive transistor causes large changes in threshold voltage, which changes are dependent on the information content of the displayed image. There will therefore be a large difference in the threshold voltage of an amorphous silicon transistor that is always on compared with one that is not. This differential ageing is a serious problem in LED displays driven with amorphous silicon transistors.

In addition to variations in transistor characteristics there is also differential ageing in the LED itself. This is due to a reduction in the efficiency of the light emitting material after current stressing. In most cases, the more current and charge passed through an LED, the lower the efficiency.

It has been recognized that a current-addressed pixel (rather than a voltage-addressed pixel) can reduce or eliminate the effect of transistor variations across the substrate. For example, a current-addressed pixel can use a current mirror to sample the gate-source voltage on a sampling transistor through which the desired pixel drive current is driven. The sampled gate-source voltage is used to address the drive transistor. This partly mitigates the problem of uniformity of devices, as the sampling transistor and drive transistor are adjacent each other over the substrate and can be more accurately matched to each other. Another current sampling circuit uses the same transistor for the sampling and driving, so that no transistor matching is required, although additional transistors and address lines are required.

There have also been proposals for voltage-addressed pixel circuits which compensate for the aging of the LED material. For example, various pixel circuits have been proposed in which the pixels include a light sensing element. This element is responsive to the light output of the display element and acts to leak stored charge on the storage capacitor in response to the light output, so as to control the integrated light output of the display during the address period.

FIG. 3 shows one example of pixel layout for this purpose. In the pixel circuit of FIG. 3, a photodiode 27 discharges the gate voltage stored on the capacitor 24. The EL display element 2 will no longer emit when the gate voltage on the drive transistor 22 reaches the threshold voltage, and the storage capacitor 24 will then stop discharging. The rate at which charge is leaked from the photodiode 27 is a function of the display element output, so that the photodiode 27 functions as a light-sensitive feedback device. It can be shown that the integrated light output, taking into the account the effect of the photodiode 27, is given by:

$${L}_{T} = \frac{{C}_{S}}{{η}_{PD}} ( V ( 0 ) - {V}_{T} ) \qquad [ 1 ]$$

In this equation, η_{PD} is the efficiency of the photodiode, which is very uniform across the display, C_{S} is the storage capacitance, V(0) is the initial gate-source voltage of the drive transistor and V_{T} is the threshold voltage of the drive transistor. The light output is therefore independent of the EL display element efficiency and thereby provides aging compensation. However, V_{T} varies across the display so it will exhibit some non-uniformity.

One further issue is that as the capacitor holding the gate-source voltage is discharged, the drive current for the display element drops gradually. Thus, the brightness tails off. This gives rise to a lower average light intensity.

These issues have been addressed in a modification in which the drive transistor is controlled to provide a constant light output from the display element. Reference is made to WO 04/084168. The optical feedback, for aging compensation, is used to alter the timing of operation (in particular the turning on) of a discharge transistor, which in turn operates to switch off the drive transistor rapidly. This can be thought of as a “snap-off” optical feedback system. The timing of operation of the discharge transistor can also be dependent on the data voltage to be applied to the pixel. In this way, the average light output can be higher than schemes which switch off the drive transistor more slowly in response to light output. The display element can thus operate more efficiently.

Furthermore, any drift in the threshold voltage of the drive transistor will manifest itself as a change in the (constant) brightness of the display element. As a result, the optical feedback circuit can also compensate for variations in output brightness resulting both from LED ageing and drive transistor threshold voltage variations.

This invention relates to this type of “snap-off” optical feedback pixel. This pixel provides good compensation for ageing of the display element, and can also compensate for variations in the drive transistor threshold voltage across the substrate. However, the voltage induced threshold variations of amorphous silicon transistors, in particular, still provide a limit to the lifetime of the display, as the optical feedback system can only tolerate variations in threshold voltage to a certain limit. Beyond this limit of threshold voltage variation, the pixel circuit will not be able to provide enough current to the display element over the full drive period to reach the desired brightness output.

The desire to provide better threshold voltage compensation has been recognized, and WO 2005/022498 discloses an arrangement with optical feedback, and with additional compensation for threshold voltage variation, using external modification of the pixel drive signals. There is still, however, a need to provide increased tolerance of the circuit to threshold voltage variations of the drive transistor without complicating the drive scheme to require external pixel data modification.

According to the invention, there is provided an active matrix display device comprising an array of display pixels, each pixel comprising:

a current-driven light emitting display element;

a drive transistor for driving a current through the display element;

a storage capacitor for storing a voltage to be used for addressing the drive transistor;

a discharge transistor for discharging the storage capacitor thereby to switch off the drive transistor;

a light-dependent device for controlling the timing of the operation of the discharge transistor by varying the gate voltage applied to the discharge transistor in dependence on the light output of the display element; and

a current source transistor for driving a predetermined current through the drive transistor, wherein the storage capacitor is adapted to store a resulting drive transistor gate-source voltage, which is a function of the threshold voltage of the drive transistor.

In this arrangement, the drive transistor can be controlled to provide a constant light output from the display element. This constant light output takes account of the threshold voltage of the drive transistor, and thereby provides compensation for threshold voltage variations. The optical feedback, for aging compensation particularly of the display element, is used to alter the timing of operation (in particular the turning on) of a discharge transistor, which in turn operates to switch off the drive transistor rapidly. This timing is also dependent on the data voltage applied to the pixel. In this way, the average light output can be higher than schemes which switch off the drive transistor more slowly in response to light output. The display element can thus operate more efficiently.

Any inaccuracies in the threshold voltage compensation of the drive transistor will manifest themselves as a change in the (constant) brightness of the display element. As a result, the optical feedback circuit of the invention compensates for variations in output brightness resulting both from LED ageing and drive transistor threshold voltage variations. This two-level threshold voltage compensation enables the optical feedback function to remain effective in compensating for threshold voltage variations for longer, increasing the lifetime of the display using the pixel circuit.

The two level compensation is, however, provided entirely within the pixel, with no need for modification to the data drive voltages. This simplifies the drive circuitry.

Each pixel preferably further comprises a bypass transistor connected between the source of the drive transistor and a bypass line. This is used as a current source circuit to drive a known current through the drive transistor, and thereby enable the storage capacitor to store a voltage which is a function of the threshold voltage of the drive transistor.

The light dependent device may comprise a photodiode or a photosensitive TFT. This may be used to charge or discharge a discharge capacitor which is provided between the gate of the discharge transistor and a constant voltage line. When the capacitor has sufficient charge (which may be more or less than originally), the discharge transistor turns on. The light dependent device is thus for discharging or charging the discharge capacitor.

Each pixel may further comprise an address transistor connected between a data signal line and an input to the pixel. The data signal on the data signal line can be provided by the address transistor to the gate of the discharge transistor. The discharge transistor is biased in use such that this results in the discharge transistor being turned off until the discharge capacitor has been charged or discharged by an amount dependent on the data voltage.

Each pixel preferably further comprises a charging transistor connected between a charging line and the gate of the drive transistor. This is used to charge the storage capacitor to a voltage which corresponds to a fully on condition of the drive transistor, and is required for n-type drive transistors with a common cathode display configuration.

The pixel circuit can be implemented using amorphous silicon n-type transistors or polysilicon n-type and p-type transistors. The polysilicon transistors may be all p-type, all n-type or a mix of n-type and p-type devices.

The invention also provides a method of driving an active matrix display device comprising an array of display pixels each comprising a drive transistor and a current-driven light emitting display element, the method comprising, for each addressing of the pixel:

applying a drive voltage to an input of the pixel;

storing a voltage derived from the drive voltage on a discharge capacitor;

using a current source circuit to drive a predetermined current through the drive transistor, and storing the resulting gate-source voltage on a storage capacitor;

using the drive transistor to drive a current through the display element using the voltage on the storage capacitor;

switching on a discharge transistor using charge flow through a light dependent device illuminated by the light output of the display element, the charge flow charging or discharging the discharge capacitor; and

discharging the storage capacitor using the discharge transistor thereby to turn off the drive transistor.

The invention will now be described by way of example with reference to the accompanying drawings, in which:

FIG. 1 shows a known EL display device;

FIG. 2 is a simplified schematic diagram of a known pixel circuit for current-addressing the EL display pixel;

FIG. 3 shows a known pixel design which compensates for differential aging;

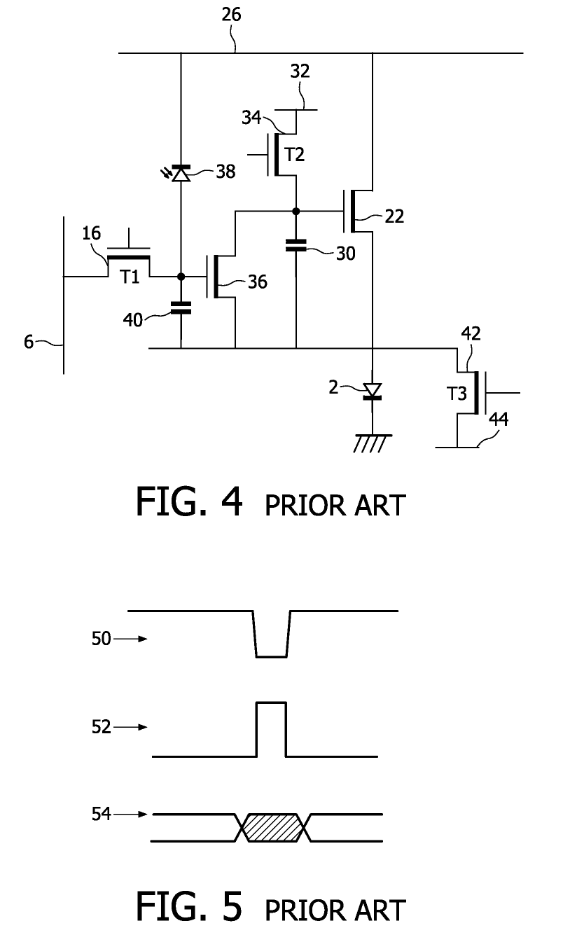

FIG. 4 shows a second known pixel circuit;

FIG. 5 is a timing diagram for explaining the operation of the circuit of FIG. 4.

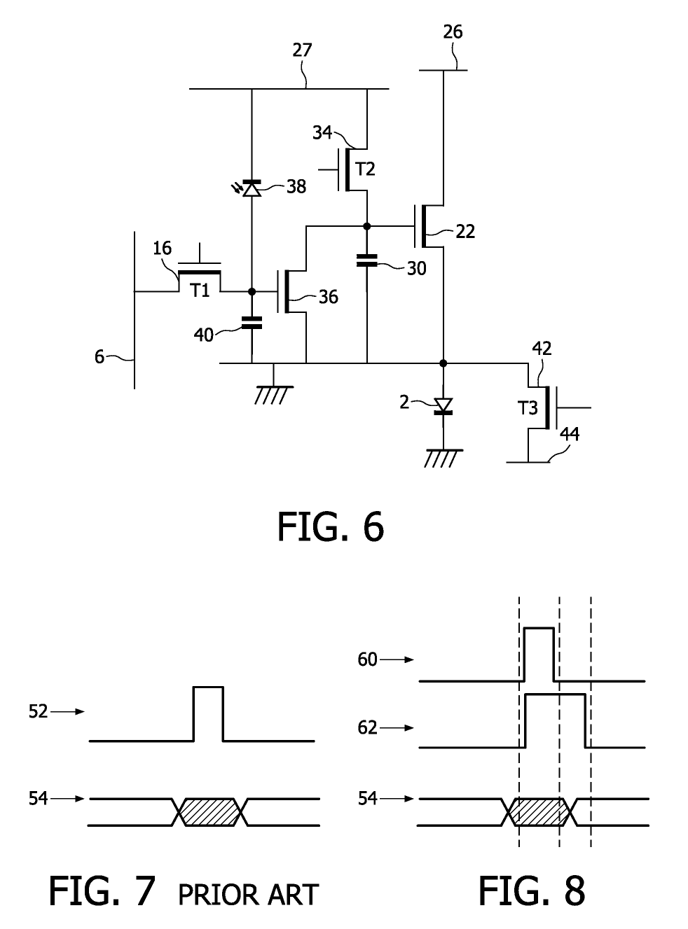

FIG. 6 shows a third known pixel circuit, and which is used to explain the method of the invention;

FIG. 7 is a timing diagram for explaining the known operation of the circuit of FIG. 6; and

FIG. 8 is a timing diagram to explain the operation of the invention.

It should be noted that these figures are diagrammatic and not drawn to scale. Relative dimensions and proportions of parts of these figures have been shown exaggerated or reduced in size, for the sake of clarity and convenience in the drawings.

FIG. 4 shows an example of “snap-off” pixel schematic which is disclosed in WO 04/084168.

The same reference numerals are used to denote the same components as in FIGS. 2 and 3, and the pixel circuit is for use in a display such as shown in FIG. 1. The circuit of FIG. 4 is suitable for implementation using amorphous silicon n-type transistors.

The gate-source voltage for the drive transistor 22 is again held on a storage capacitor 30. This capacitor is charged to a fixed voltage from a charging line 32, by means of a charging transistor 34 (T2). Thus, the drive transistor 22 is driven to a constant level which is independent of the data input to the pixel when the display element is to be illuminated. The brightness is controlled by varying the duty cycle, in particular by varying the time when the drive transistor is turned off.

The drive transistor 22 is turned off by means of a discharge transistor 36 which discharges the storage capacitor 30. When the discharge transistor 36 is turned on, the capacitor 30 is rapidly discharged and the drive transistor turned off.

The discharge transistor is turned on when the gate voltage reaches a sufficient voltage. A photosensor 38 (shown as a photodiode) is illuminated by the display element 2 and generates a photocurrent in dependence on the light output of the display element 2. This photocurrent charges a discharge capacitor 40, and at a certain point in time, the voltage across the capacitor 40 will reach the threshold voltage of the discharge transistor 40 and thereby switch it on. This time will depend on the charge originally stored on the capacitor 40 and on the photocurrent, which in turn depends on the light output of the display element.

Thus, the data signal provided to the pixel on the data line 6 is supplied by the address transistor 16 (T1) and is stored on the discharge capacitor 40. A low brightness is represented by a high data signal (so that only a small amount of additional charge is needed for the transistor 36 to switch off) and a high brightness is represented by a low data signal (so that a large amount of additional charge is needed for the transistor 36 to switch off).

This circuit thus has optical feedback for compensating ageing of the display element, and also has threshold compensation of the drive transistor 22, because variations in the drive transistor characteristics will also result in differences in the display element output, which are again compensated by the optical feedback. For the transistor 36, the gate voltage over threshold is kept very small, so that the threshold voltage variation is much less significant.

As shown in FIG. 4, each pixel also has a bypass transistor 42 (T3) connected between the source of the drive transistor 22 and a bypass line 44. This bypass line 44 can be common to all pixels. This is used to ensure a constant voltage at the source of the drive transistor when the storage capacitor 30 is being charged. Thus, it removes the dependency of the source voltage on the voltage drop across of the display element, which is a function of the current flowing. Thus, a fixed gate-source voltage is stored on the capacitor 30, and the display element is turned off when a data voltage is being stored in the pixel.

FIG. 5 shows timing diagrams for the operation of the circuit of FIG. 4 and is used to explain the circuit operation in further detail.

The power supply line has a switched voltage applied to it. Plot 50 shows this voltage. During the writing of data to the pixel, the power supply line 26 is switched low, so that the drive transistor 22 is turned off. This enables the bypass transistor 42 to provide a good ground reference.

The control lines for the three transistors T1, T2, T3 are connected together, and the three transistors are all turned on when the power supply line is low. This shared control line signal is shown as plot 52.

Turning on T1 has the effect of charging the discharge capacitor 40 to the data voltage. Turning on T2 has the effect of charging the storage capacitor 30 to the constant charging voltage from charging line 32, and turning on T3 has the effect of bypassing the display element 2 and fixing the source voltage of the drive transistor 22. As shown in plot 54, data (the hatched area) is applied to the pixel during this time.

In order to avoid the need for power line switching, the arrangement shown in FIG. 6 can be used. The same reference numerals are used for the same components, and the circuit is again shown implemented with n-type transistors only, and is therefore suitable for implementation using amorphous silicon transistors. In this circuit, the voltage on the power supply line 26 is not switched. The charging line has also been shown as a separate power supply line 27 to the drive transistor power supply line 26. The anode of the display element is no longer connected to the lower terminal of the discharge capacitor 40, and this enables the voltage on the bypass line to be made independent of the low voltage line of the remainder of the pixel.

FIG. 7 shows the known timing diagram for this circuit. The storage of data in the pixel is carried out when all three transistors T1, T2, T3 are turned on, by plot 52.

In this circuit, the voltage applied to the bypass line 44 is selected to be below the threshold of the display element 2, so that the display element is turned off during pixel programming, without needing to switch the voltage on the power supply line 26. Avoiding power line switching makes implementation of the driver circuitry less complicated.

One problem with this approach is that the circuit can only provide limited compensation for threshold voltage variations of the drive transistor. In the case of amorphous silicon drive transistors, these variations will be much more significant than the variations in pixel characteristics resulting from the ageing of the display element.

The invention provides additional compensation for the threshold voltage of the drive transistor, and using the bypass line and bypass transistor.

The circuit is modified to provide independent control of the bypass transistor 42 and the addressing transistor 16/charging transistor 34.

The timing diagram for one example of the method of the invention is shown in FIG. 8.

The address transistor 16 and charging transistor are controlled by a first control line, and the timing is shown as plot 60. The bypass transistor 42 is controlled by a second control line, and the timing is shown as plot 62. The data is shown as plot 64.

The invention uses the bypass transistor as a current source, which causes a known current to be driven through the drive transistor 22. Thus, the transistor 42 is no longer operated as a switch which simply sinks the current from the drive transistor, but is operated as a current controlling device, which governs the current drawn through the drive transistor 22.

The addressing cycle is divided into two phases. In the first phase, the two control lines are high so that the address transistor 16, the charging transistor 34 and the bypass transistor 42 are all turned on.

In the same way as described above, the capacitor 40 is charged to the pixel data voltage.

The transistor 42 operates as a current source, and the voltage of the control line is selected to provide a predetermined current flow. In particular, the current flow corresponds to the fixed current that is to be driven through the display element during the light output phase of the pixel.

During this phase, the gate of the drive transistor 22 is held at the high voltage of the power rail 27, and the source will reach an equilibrium voltage at which the gate-source voltage of the drive transistor 22 corresponds to a particular current flow, which is the same current corresponding to the fixed gate source voltage of the bypass transistor 42. The gate source voltage of the bypass transistor 42 is determined by the voltage on the bypass line 44 and the control voltage level.

This equilibrium is designed such that the anode voltage is below the threshold voltage of the display element.

For example, the voltage on rail 27 may be approximately 5V to 10V higher than the threshold of the drive transistor, for example a voltage rail level of 10V. The voltage on the bypass line 44 may be approximately −20V, to ensure that the voltage on the anode remains below the display element threshold voltage, which is for example approximately 2V.

The bypass transistor passes a current:

$${I}_{42} = \frac{b}{2} {( Vg - {V}_{44} - {Vt}_{42} )}^{2}$$

V₄₄ is the voltage on the bypass line, Vg is the gate control voltage for the bypass transistor, Vt₄₂ is the threshold voltage for the bypass transistor and b is the transconductance parameter for the bypass transistor.

This current must be passed by the drive transistor, which has the charging line voltage V₂₇ on its gate. Thus:

$${I}_{22} = \frac{c}{2} {( {V}_{27} - {V}_{anode} - {Vt}_{22} - {dVt}_{22} )}^{2}$$

In the above equation, V₂₇ is the voltage on the charging line 27, c is the transconductance parameter for the drive transistor, Vt₂₂ is the threshold voltage of the drive transistor at time zero, and dVt₂₂ is the change in the threshold voltage since time zero. If the two transistors are the same (initial Vt values Vt₄₂, Vt₄₄ the same and b and c the same). the anode voltage V_{anode} is then:

V_{anode}=(V₂₇+V₄₄−Vg−dVt₂₂)

Using the example above, the voltage for the charging line 27 is 10V, the bypass line voltage is −20V and the bypass gate voltage is −10V. In this case, the anode voltage is equal to −dVt₂₂, namely the anode voltage drops with the threshold voltage to keep the equilibrium. By starting with a gate voltage of −10V, the drop in the anode voltage from 0 to −6V (representing a threshold voltage change of 6V over the lifetime of the display) can be tolerated, as the gate voltage of −10V still turns the transistor on, and anode voltage is then low enough to keep the display element off. The drive transistor has a gate voltage of the charging line voltage plus the change in threshold voltage (V₂₇+dVt₂₂).

The voltage across the capacitor 30 can thus be considered to provide a fixed component and a variable component, which depends on the equilibrium point reached by the anode voltage. This variable component depends on the drive transistor characteristics, in particular this represents a sampling of the drive transistor threshold voltage change.

This mechanism thereby provides compensation for the threshold voltage of the drive transistor, by providing a variable component which depends on the threshold voltage. The combined voltage is effectively the threshold voltage of the drive transistor plus an additional voltage which is the same for all pixels of the display.

The mobility of amorphous silicon transistors is temperature sensitive. The current programming/sampling step used in this method also provides compensation for temperature dependent mobility variations.

The control line for the address transistor 16 and charging transistor 34 goes low as shown in plot 62, and some time later the control line for the bypass transistor 42 is brought low as shown in plot 64. By leaving the bypass transistor on for an additional period of time, the display element is held off, so that in the case of a black pixel, the discharge transistor 36 is able to operate before any light is output, and thereby provide good contrast. This also enables the current programming step to settle.

Current is then driven through the display element, and this current corresponds to the sampled current level, as the corresponding gate source voltage was sampled on the capacitor 30. The optical feedback system operates in the same way as described above, to compensate for the display element degradation, but also to compensate for any residual errors in the threshold and mobility compensation provided by the current source sampling technique described above. This means the current source sampling stage does not need to provide accurate compensation for threshold voltage variations. Instead, it provides a coarse compensation so that the finer compensation enabled by the optical feedback system is able to function over a much longer time range, prolonging the life of the display.

In the example above, the drive transistor is described having the same design/dimensions as the drive transistor, but the drive transistor can be smaller, and the anode voltage will still vary with dVt.

The example above is a common-cathode implementation, in which the anode side of the LED display element is patterned and the cathode side of all LED elements share a common unpatterned electrode. This is the current preferred implementation as a result of the materials and processes used in the manufacture of the LED display element arrays. However, patterned cathode designs are being implemented, and this can simplify the pixel circuit.

Common-anode pixel configurations are discussed and examples given in WO 04/084168, and this invention can be implemented for common-anode pixel configurations in the same way.

The circuit is an n-type only arrangements which are therefore suitable for amorphous silicon implementation.

The invention can also be used for implementation using a low temperature polysilicon process, in which case an n-type and p-type circuit may be preferred.

In the example above, the light dependent element is a photodiode, but pixel circuits may be devised using phototransistors or photoresistors.

A number of transistor semiconductor technologies have been mentioned above. Further variations are possible, for example crystalline silicon, hydrogenated amorphous silicon, polysilicon and even semiconducting polymers. These are all intended to be within the scope of the invention as claimed. The display devices may be polymer LED devices, organic LED devices, phosphor containing materials and other light emitting structures.

There are alternative ways to prevent the display element emitting light during the pixel programming stage. The example above uses a bypass transistor to provide an anode voltage which does not turn on the display element. It is instead possible to provide an isolating transistor between the drive transistor and the display element. This can be used in combination with the current sampling technique of the invention.

Various other modifications will be apparent to those skilled in the art.

1. An active matrix display device, comprising:
a current-driven light emitting display element;
a drive transistor for driving a current through the display element;
a storage capacitor for storing a voltage to be used for addressing the drive transistor;
a discharge transistor for discharging the storage capacitor to switch off the drive transistor;
a light-dependent device for controlling the timing of the operation of the discharge transistor by varying the gate voltage applied to the discharge transistor in dependence on the light output of the display element; and
a current source transistor for driving a predetermined current through the drive transistor, wherein the storage capacitor stores a resulting drive transistor gate-source voltage, which is a function of the threshold voltage of the drive transistor.

2. A device as claimed in claim 1, further comprising a bypass transistor connected between the source of the drive transistor and a bypass line.

3. A device as claimed in claim 2, wherein the bypass transistor drives a substantially constant current through the drive transistor during storage on the storage capacitor of the voltage to be used for addressing the drive transistor.

4. A device as claimed in claim 1, wherein the storage capacitor is connected between the gate and source of the drive transistor.

5. A device as claimed in claim 1, wherein the light-dependent device controls the timing of the switching of the discharge transistor from an off to an on state.

6. A device as claimed in claim 1, wherein the light dependent device comprises a discharge photodiode.

7. A device as claimed in claim 1, wherein a discharge capacitor is provided between the gate of the discharge transistor and a constant voltage line, and the light dependent device is for charging or discharging the discharge capacitor.

8. A device as claimed in claim 1, further comprising an address transistor connected between a data signal line and an input to the pixel.

9. A device as claimed in claim 1, wherein the drive transistor is connected between a power supply line and the display element.

10. A device as claimed in claim 1, further comprising a charging transistor connected between a charging line and the gate of the drive transistor.

11. A device as claimed in claim 1, wherein the transistors comprise amorphous silicon n-type transistors.

12. A device as claimed in claim 1, wherein the current-driven light emitting display element comprises an electroluminescent display element.

13. A method of driving an active matrix display device comprising a drive transistor and a current-driven light emitting display element, the method comprising:
applying a drive voltage to an input of the pixel;
storing a voltage derived from the drive voltage on a discharge capacitor;
using a current source circuit to drive a predetermined current through the drive transistor and storing the resulting gate-source voltage on a storage capacitor;
using the drive transistor to drive a current through the display element using the voltage on the storage capacitor;
switching on a discharge transistor using charge flow through a light dependent device illuminated by the light output of the display element, the charge flow charging or discharging the discharge capacitor; and
discharging the storage capacitor using the discharge transistor to turn off the drive transistor.

14. A method as claimed in claim 13, wherein using a current source circuit to drive a predetermined current through the drive transistor comprises driving a current through a bypass transistor which connects to the drive transistor, wherein a resulting voltage on a source or drain of the drive transistor terminal results in the display element being turned off.

15. A method as claimed in claim 13, wherein the predetermined current corresponds to the current to be driven through the display element.
